(19) United States
(12) Patent Application Publication
(10) Pub. No.: US 2026/0106461 A1
(43) Pub. Date: Apr. 16, 2026

(54) ELECTRIFIED VEHICLE EQUIPPED WITH ENGINE AND CONTROL METHOD THEREOF

(71) Applicants: HYUNDAI MOTOR COMPANY, Seoul (KR); KIA CORPORATION, Seoul (KR)

(72) Inventors: Tae Jun Moon, Hwaseong-si (KR); Ho Rim Choi, Hwaseong-si (KR); Jin Wook Kang, Hwaseong-si (KR); Tae Gyeom Woo, Hwaseong-si (KR); Tae Il Yoo, Hwaseong-si (KR); Sang Woo Park, Hwaseong-si (KR)

(73) Assignees: HYUNDAI MOTOR COMPANY, Seoul (KR); KIA CORPORATION, Seoul (KR)

(21) Appl. No.: 19/066,625

(22) Filed: Feb. 28, 2025

(30) Foreign Application Priority Data
Oct. 11, 2024 (KR) 10-2024-0138830

(51) Int. Cl. H02J 7/24; B60L 50/51; B60L 50/62; B60L 53/22; B60L 53/57; B60L 53/62

(52) U.S. Cl. CPC H02J 7/24; B60L 50/51; B60L 50/62; B60L 53/22; B60L 53/57; B60L 53/62; B60L 2210/10; B60L 2210/30; B60L 2240/44; B60L 2240/547; H02J 2207/20

(57) ABSTRACT

An electrified vehicle is disclosed. The electrified vehicle may include a battery, an engine, a motor configured to generate power by receiving mechanical energy from the engine, a power converter configured to rectify the alternating current (AC) power generated by the motor into direct current (DC) power, convert the voltage of the rectified power into a charging voltage, and output the converted voltage to the battery, and a controller configured to determine a voltage conversion duty ratio based on the voltage of the rectified power and the voltage of the battery, wherein the power converter converts the voltage of the rectified power into the charging voltage based on a control signal corresponding to the voltage conversion duty ratio.

### CROSS-REFERENCE TO RELATED APPLICATION(S)

The present application claims priority to Korean Patent Application No. 10-2024-0138830, filed Oct. 11, 2024, the entire contents of which is incorporated herein for all purposes by this reference.

### TECHNICAL FIELD

The disclosure relates to an electrified vehicle capable of extending its driving range using a power generation engine and a driving control method thereof.

### BACKGROUND

With the growing interest in the environment, there is a trend of increasing eco-friendly vehicles equipped with electric motors as power sources. Eco-friendly vehicles are also known as electrified vehicles, with representative examples being hybrid electric vehicles (HEVs) and electric vehicles (EVs).

Among these, electric vehicles operate (e.g., solely) on electric motors, powered by electricity supplied from batteries. However, EVs face may have a (e.g., relatively) limited driving range and long charging times.

Thus, extended range electric vehicles (EREVs) have been considered, which incorporate a power generation engine to increase driving range. Unlike EVs, EREVs may include an engine and motor to generate electricity for charging the battery, and EREVs may use an inverter to supply the generated electricity to the battery.

This background section is intended to aid in understanding of the disclosure, and should not be construed as prior art.

### SUMMARY

The disclosure herein is to provide an electrified vehicle capable of stably converting the voltage range of generated power according to (e.g., optimal) engine operation.

The disclosure herein further is to provide an electrified vehicle with (e.g., easy and highly stable) voltage control of the generated power.

The disclosure is not limited to the aforementioned, and other objects not described herein may be understood from the descriptions herein.

Herein, an electrified vehicle is provided. In an example embodiment, the electrified vehicle may include a battery, an engine, a motor configured to generate power by receiving mechanical energy from the engine, a power converter configured to rectify the alternating current (AC) power generated by the motor into direct current (DC) power, convert voltage of the rectified power into a charging voltage, and output the converted voltage to the battery. The electrified vehicle also may include a controller configured to determine a voltage conversion duty ratio based on the voltage of the rectified power and the voltage of the battery, wherein the power converter may convert the voltage of the rectified power into the charging voltage based on a control signal corresponding to the voltage conversion duty ratio.

According to an example embodiment, the power converter may include a buck-boost converter configured to step up or step down the charging voltage based on the voltage conversion duty ratio.

According to an example embodiment, the buck-boost converter may include a switch disposed at an input terminal configured to receive the rectified power, the switch being controlled to turn on and off based on the control signal.

According to an example embodiment, the switch disposed at the input terminal may include a plurality of switching elements connected in series.

According to an example embodiment, the motor may include a three-phase motor, and the power converter may include a three-phase rectifier configured to convert the three-phase AC power generated from the power generation motor into DC power.

According to an example embodiment, the controller may determine the charging voltage based on the voltage of the battery and determine the voltage conversion duty ratio based on the charging voltage and the rectified power voltage.

According to an example embodiment, the controller may further determine whether the voltage of the battery is below a predetermined reference voltage and control the engine to operate based on the battery voltage being below the reference voltage.

According to an example embodiment, the engine may be operated in a predetermined driving mode based on the energy efficiency of the engine.

A method for controlling an electrified vehicle is provided. In an example embodiment, the method may include operating an engine by a controller, generating power via a motor by receiving mechanical energy from the engine, and rectifying the alternating current (AC) power generated by the motor into direct current (DC) power via a power converter, and determining, by the controller, a voltage conversion duty ratio based on the voltage of the rectified power and the voltage of the battery, wherein the power converter may convert the voltage of the rectified power into the charging voltage based on a control signal corresponding to the voltage conversion duty ratio.

According to an example embodiment, the power converter may include a buck-boost converter configured to step up or step down the charging voltage based on the voltage conversion duty ratio.

According to an example embodiment, the buck-boost converter may include a switch disposed at an input terminal configured to receive the rectified power, the switch being controlled to turn on and off based on the control signal.

According to an example embodiment, the switch disposed at the input terminal may include a plurality of switching elements connected in series.

According to an example embodiment, the motor may include a three-phase motor, and the power converter may include a three-phase rectifier configured to convert the three-phase AC power generated from the power generation motor into DC power.

According to an example embodiment, determining of the duty ratio may include determining, by the controller, the charging voltage based on the voltage of the battery and determining the voltage conversion duty ratio based on the charging voltage and the voltage of the rectified current.

According to an example embodiment, the method may further include determining whether the voltage of the battery is below a predetermined reference voltage, and operating the engine based on the battery voltage being below the reference voltage.

According to an example embodiment, the engine may be operated in a predetermined driving mode based on the energy efficiency of the engine.

According to example embodiments of the disclosure as described herein, it may be useful to provide an electrified vehicle capable of (e.g., stably) converting the voltage range of generated power based on (e.g., optimal) engine operation.

It may also be useful to provide an electrified vehicle with (e.g., easy and highly stable) voltage control of the generated power.

The disclosure is not limited to the aforementioned, and other uses and details not described herein may be understood from the description herein.

### BRIEF DESCRIPTION OF THE DRAWINGS

FIG. 1 is a diagram of the configuration of an EREV according to an embodiment of the disclosure;

FIG. 2 is a diagram of the process in which the power generated by driving a power generation engine is charged into a battery;

FIG. 3 is a diagram of the control system configuration of the EREV according to an embodiment of the disclosure;

FIG. 4 is a diagram of the configuration of the power converter according to an embodiment of the disclosure;

FIG. 5 is a graph of the voltage inside the power converter according to an embodiment of the disclosure;

FIG. 6 is a graph of the duty cycle of the buck-boost converter according to an embodiment of the disclosure; and

FIG. 7 is a flowchart of how a VCU controls the battery charging operation using the power generation engine according to an embodiment of the disclosure.

### DETAILED DESCRIPTION

The structural or functional descriptions of the embodiments disclosed herein are illustrative examples intended to describe embodiments of the disclosure, and the embodiments of the disclosure can be provided (e.g., implemented) in various forms and should not be construed as being limited to those described herein.

The embodiments of this disclosure can have various modifications and can take on different forms, although example embodiments are illustrated in the drawings and described in detail herein.

Unless otherwise defined, (e.g., all) terms used herein, including technical or scientific terminology, may have the same meaning as commonly understood. Terms herein should be interpreted in a manner similar or consistent with their meaning in the context of the relevant field unless (e.g., explicitly) defined in this specification.

The following provides a description of the example embodiments disclosed in this specification with reference to the attached drawings, assigning similar or identical reference numerals to similar or identical components across the drawings and omitting redundant descriptions thereof.

In the description of the embodiments, the term “predetermined” provides (e.g., means) that the numerical values of parameters may be established in advance when using the parameters in a process or algorithm. The numerical values of the parameters may be set at the beginning of the process or algorithm or may be established during the execution of the process or algorithm, depending on the embodiment.

As used herein, the suffix “module” and “unit” may be used interchangeably but, by itself, may have no distinct meaning or role.

In addition, some detailed descriptions of known technologies related to the embodiments disclosed in the present specification may be omitted if the description obscures the subject matter of the embodiments disclosed herein. In addition, the accompanying drawings may provide an understanding of the embodiments disclosed in the present specification and may not limit the disclosed herein. The embodiments herein may include (e.g., all) changes, equivalents, and substitutes within the scope of the disclosure.

As used herein, terms including an ordinal number such as “first” and “second” can be used to describe various components without limiting the components. The terms may be used for distinguishing one component from another component.

When a component is referred to as “connected to” or “coupled to” another component, it may be (e.g., directly) connected or coupled to the other component or an intervening component may be present. In contrast, when a component is referred to as being “directly connected to” or “directly coupled to” another component, there may be no intervening components present.

The singular forms are intended to include the plural forms as well unless the context indicates otherwise.

The terms “comprises” or “has,” when used in this specification, may indicate the presence of a stated feature, number, step, operation, component, element, or a combination thereof, but do not preclude the presence or addition of one or more other features, numbers, steps, operations, components, elements, or combinations thereof.

In addition, the terms “unit” or “control unit” included in the names of motor control units (MCUs) or vehicle control units (VCUs) may be used to describe controllers responsible for (e.g., specific) functions of a vehicle, rather than indicating a generic function unit.

The electrified vehicle herein may be an EREV, which increases driving range by adding an engine and motor to generate electricity that charges the battery.

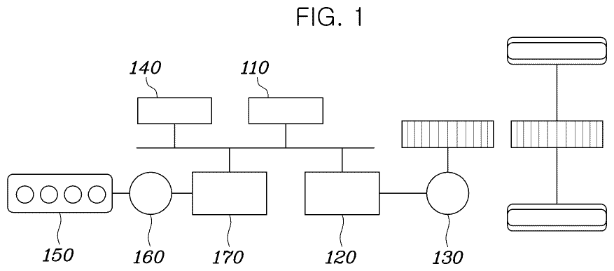

FIG. 1 is a diagram of the configuration of an EREV according to an embodiment of the present disclosure.

With reference to FIG. 1, the EREV may include a battery 110, an inverter 120, a drive motor 130, a charger 140, an engine 150, a power generation motor 160, and a power converter 170.

The battery 110 may store power and supply power to the inverter 120 and drive motor 130 for driving the EREV.

The inverter 120, which includes a plurality of switches, may convert the power output from the battery 110 into a form suitable for driving the motor 130. For example, the inverter 120 may take the direct current (DC) power output from the battery 110 and convert the DC power into three-phase alternating current (AC) power for the drive motor 130.

The drive motor 130 may drive the EREV based on the power received from the inverter.

However, the inverter 120 and drive motor 130 may not be (e.g., solely) responsible for driving the vehicle. For example, during deceleration, the inverter 120 and drive motor 130 may perform regenerative braking by converting the driving force of the wheels into electrical energy to charge the battery 110. In an example embodiment, during regenerative braking, the drive motor 130 may convert the driving force of the wheels into AC power, and the inverter 120 may convert the generated AC power into DC power to charge the battery 110.

The charger 140 is connected to an external power source and may charge the battery 110 based on the power received from the external power source.

The power generation engine 150 may generate power by burning fuel. The power generated by the power generation engine 150 is used (e.g., only) to generate electricity for charging the battery 110 and is not transmitted to the vehicle's wheels to directly drive the EREV. Additionally, the power generation engine 150 may operate in a predetermined driving mode based on its energy efficiency. For example, the predetermined driving mode may be a mode that drives the power generation engine 150 at the optimal efficiency point.

The power generation motor 160 may convert the power received from the engine 150 into AC power. The power generation motor 160 may include a three-phase motor and may be directly coupled to the engine shaft of the engine 150 to rotate together.

The power converter 170 rectifies the AC power generated from the power generation motor 160 into DC power and converts the voltage of the rectified power into a charging voltage to charge the battery 110. To achieve this, the power converter 170 may include a rectifier that converts the AC power generated from the power generation motor 160 into DC power and a buck-boost converter that steps up or steps down the charging voltage to charge the battery 110.

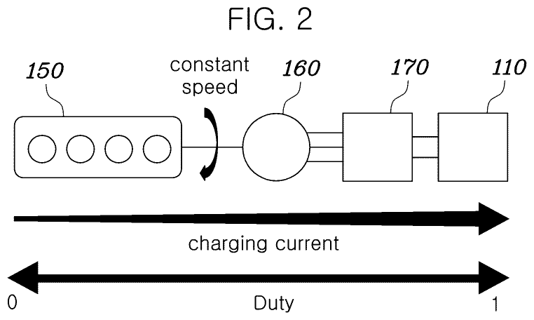

FIG. 2 is a diagram of the process in which the power generated by driving a power generation engine is charged into a battery.

FIG. 2 illustrates the speed control form of the power generation engine 150 and the relationship between the charging current magnitude and duty during battery charging voltage control for charging the battery 110.

When controlling the charging voltage of the battery 110, the power generation engine 150 may operate in a predetermined driving mode considering the optimal operating point. The power generation engine 150 may rotate at a constant speed corresponding to its optimal operating point.

The power generation motor 160 is configured as a three-phase motor, converting the power generated by the power generation engine 150 into electrical energy. The load of the power generation motor 160 is controlled by the power generation engine 150 operating at a constant speed, and torque control of the power generation motor 160 based on variable resistance may not be performed separately.

The rectifier of the power converter 170 rectifies the generated AC power into DC power, and the buck-boost converter may convert the voltage of the rectified power into a charging voltage to charge the battery 110.

In an example embodiment, when the voltage conversion duty ratio of the control signal received by the buck-boost converter decreases, the magnitudes of the charging voltage and charging current output from the buck-boost converter may decrease, and when the voltage conversion duty ratio increases, the magnitudes of the charging voltage and charging current output from the buck-boost converter may increase. The power converter 170, which includes such a rectifier and buck-boost converter, may be useful (e.g., advantageous) for packaging configuration and cost (e.g., compared to a six-switch converter that includes six switches).

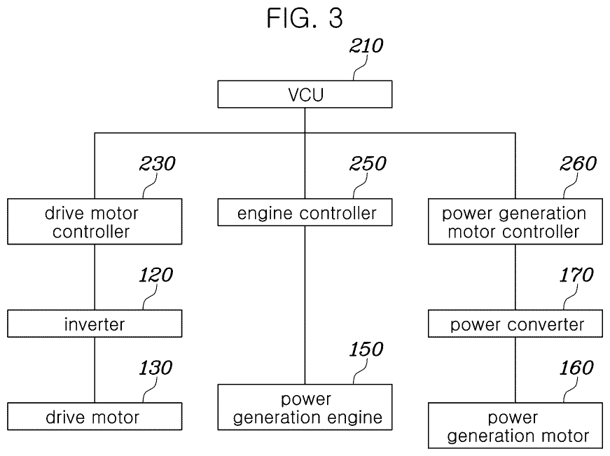

FIG. 3 is a diagram of the control system configuration of the EREV according to an embodiment of the present disclosure.

With reference to FIG. 3, in the EREV, the inverter 120 and the drive motor 130 may be controlled by the drive motor controller 230, the power generation engine 150 may be controlled by the engine controller 250, and the power generation motor 160 and the power converter 170 may be controlled by the power generation motor controller 260.

Each controller is connected to the vehicle control unit (VCU) 210 that controls the (e.g., entire) powertrain as the upper-level controller, providing the VCU 210 with information (e.g., necessary) for determining the operation and stoppage of the engine or motor or performing actions according to control commands received from the VCU 210.

The drive motor controller 230 may control the gate drive unit with a pulse-width modulation (PWM) control signal based on the motor angle, phase voltage, phase current, and (e.g., required) torque of the drive motor 130, providing (e.g., enabling) the gate drive unit to control the inverter 120 that drives the drive motor 130 accordingly.

The power generation motor controller 260 is connected to the power converter 170 and may control the charging voltage for the battery 110. For example, the power generation motor controller 260 determines the duty ratio of the control signal output from the buck-boost converter of the power converter 170 and outputs a control signal based on the determined duty ratio to the buck-boost converter to control the charging voltage output to the battery 110.

The connections between the control units and the functions/classifications of each controller are exemplary and may not be limited to the names. For example, the VCU 210 may be provided (e.g., implemented) such that the corresponding functions are provided by any one of the other controllers, or the functions may be distributed among two or more of the other controllers.

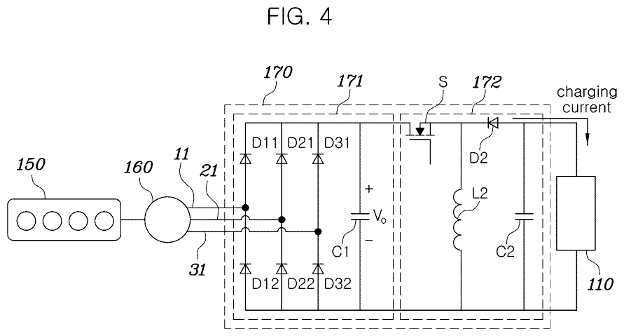

FIG. 4 is a diagram of the configuration of the power converter according to an embodiment of the disclosure.

With reference to FIG. 4, the power converter 170 may include a three-phase rectifier 171 that rectifies the three-phase alternating current power generated from the engine 150 and power generation motor 160 into direct current power, and a buck-boost converter 172 that converts the voltage of the rectified power into a charging voltage for output to the battery 110.

The three-phase rectifier 171 is a device that converts alternating current power into direct current power and may include a plurality of diodes D11, D12, D21, D22, D31, and D32, along with a capacitor C1. In an example embodiment, the three-phase rectifier may include an a-phase input terminal 11, a b-phase input terminal 21, and a c-phase input terminal 31 that receive the a-phase, b-phase, and c-phase power, respectively.

In an example embodiment, the first to sixth diodes D11, D12, D21, D22, D31, and D32 may constitute the legs corresponding to each phase of the generated three-phase alternating current power. For example, the first leg may be composed of the first diode D11 and the second diode D12 connected to the a-phase input terminal 11, the second leg may be composed of the third diode D21 and the fourth diode D22 connected to the b-phase input terminal 21, and the third leg may be composed of the fifth diode D31 and the sixth diode D32 connected to the c-phase input terminal 31.

Additionally, the first capacitor C1 may stabilize the voltage rectified by the three-phase rectifier 171 and reduce the ripple voltage of the rectified power. The voltage measured with respect to both terminals of the first capacitor Cl will be referred to herein as the rectified voltage V1 of the three-phase rectifier 171.

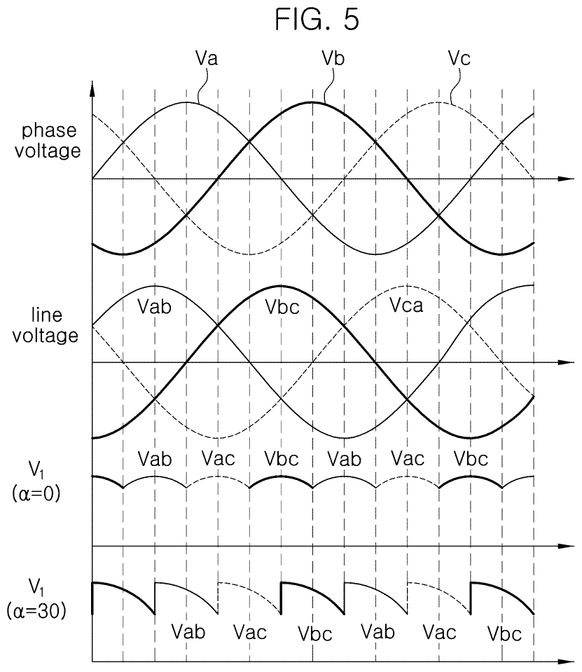

FIG. 5 is a graph of the voltage inside the power converter according to an embodiment of the present disclosure.

With reference to FIG. 5, a horizontal axis represents time, and the vertical axis displays graphs representing the phase voltage, line voltage, rectified voltage when the phase delay angle is 0 degrees, and rectified voltage when the phase delay angle is 30 degrees, from top to bottom, respectively.

The phase voltage graph shows the phase voltages corresponding to each phase (e.g., a-phase, b-phase, and c-phase) of the three-phase rectifier 171.

In an example embodiment, the phase voltage graph shows the time-varying voltage of the a-phase voltage, b-phase voltage, and c-phase voltage, which fluctuate periodically as alternating waveforms, with each phase voltage varying by 120 degrees in phase.

Additionally, the line voltage graph shows the line voltage between the first to third input terminals 11, 21, and 31 corresponding to each phase, that is, the line voltage Vab between the first input terminal 11 and the second input terminal 21, the line voltage Vbc between the second input terminal 21 and the third input terminal 31, and the line voltage between the third input terminal 31 and the first input terminal 11.

Depending on the inductance and capacitance characteristics of the power generation engine 150, power generation motor 160, and three-phase rectifier 171, a delay angle a may occur for the rectified voltage V1 output from the three-phase rectifier 171.

When examining the graph of the rectified voltage V1 with a delay angle a of 0, the rectified voltage V1 is (e.g., relatively) stable with minimal ripple when the delay angle a is 0 degrees.

Conversely, when the delay angle a is 30 degrees, the graph of the rectified voltage V1 shows that each phase voltage is delayed by 30 degrees, resulting in an increased ripple of the rectified voltage V1 and a decrease in the effective power output.

The three-phase alternating voltage of the power generation motor 160 is rectified into direct current voltage using the three-phase rectifier 171, providing (e.g., allowing) for phase shifting based on current magnitude to improve the power factor and control harmonic characteristics. For example, the VCU 210 may control the voltage conversion duty of the signal output to the buck-boost converter 172 based on the magnitude of the rectified voltage V1 that reflects the delay angle, maximizing the conversion efficiency of the power charged to the battery and providing a stable direct current power supply.

Referring back to FIG. 4, the buck-boost converter 172 is a device that converts the rectified voltage V1 into a charging voltage V2 based on a control signal corresponding to the voltage conversion duty ratio and may include a switch S, an inductor L2, a diode D2, and a second capacitor C2.

A six-switch converter that converts power by controlling each of the six switches may adjust the magnitude of the regenerative torque of the power generation motor based on the signals output from each switch, thereby regulating the power and voltage being charged to the battery. In contrast, the power converter 170, which converts the power generated based on the three-phase rectifier 171 and the buck-boost converter 172, may regulate the voltage magnitude of the power output to the battery 110 by controlling the voltage conversion duty ratio of the control signal output from the buck-boost converter 172.

In an example embodiment, the switch S may be composed of power devices with a (e.g., relatively) high voltage rating (e.g., IGBT or MOSFET), as a (e.g., relatively) high voltage may be applied to it. In an example embodiment, the switch S may include a plurality of switching elements connected in series to reduce the voltage magnitude applied to each element.

In an example embodiment, the control signal corresponding to the voltage conversion duty ratio is applied to the switch S, allowing the charging voltage V2 output to be stepped up or stepped down according to the determined voltage conversion duty ratio. When the switch S includes a plurality of switching elements, the control signal corresponding to the voltage conversion duty ratio may be applied to the gate of each switching element.

The voltage conversion duty ratio may be determined based on the rectified voltage V1 of the rectified power and the charging voltage V2 for charging the battery 110. More specifically, the voltage conversion duty ratio) may be determined by substituting into the following equation based on the rectified voltage V1 and the charging voltage V2.

$${v}_{2} = \frac{D}{1 - D} {v}_{1} \qquad Equation$$

In the Equation, v₁ is the rectified voltage, 22 is the charging voltage, and D is the voltage conversion duty ratio.

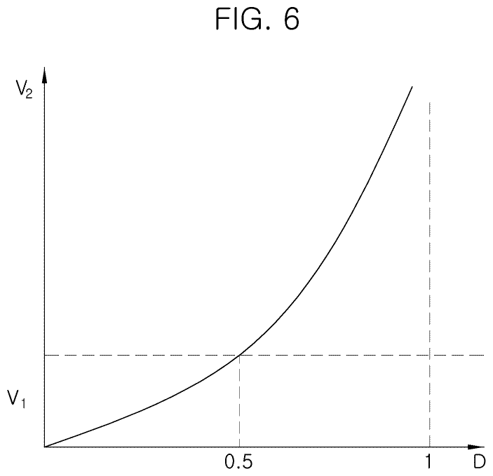

FIG. 6 is a graph of the duty cycle of the buck-boost converter according to an embodiment of the present disclosure.

FIG. 6 illustrates a graph of the charging voltage V2 based on the voltage conversion duty ratio D in the buck-boost converter 172.

In an example embodiment, when the voltage conversion duty ratio D received from the power generation motor controller 260 by the buck-boost converter 172 is less than 0.5, the rectified voltage V1 input to the buck-boost converter 172 may be output as a reduced charging voltage V2, while when the duty ratio D is equal to 0.5, the charging voltage V2 may be the same as the rectified voltage V1, and when greater than 0.5, the rectified voltage V1 may be boosted, resulting in a charging voltage V2 that is greater than the rectified voltage V1.

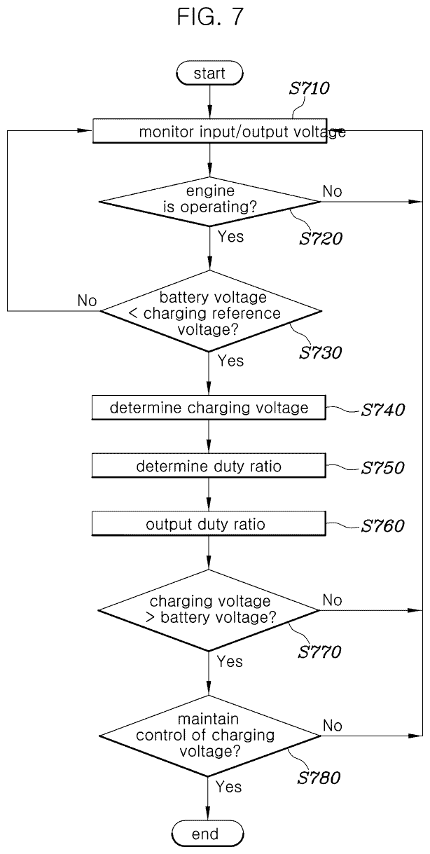

FIG. 7 is a flowchart of how a VCU controls the battery charging operation using the power generation engine according to an embodiment of the present disclosure.

With reference to FIG. 7, the VCU 210 may monitor the input and output voltages of each component in operation S710 and determine in operation S720 whether the power generation engine 150 is operating.

For example, the VCU 210 may monitor the rectified voltage V1 from the power converter 170, the charging voltage V2 output to the battery 110, and the voltage of the battery 110.

When it is determined that the power generation engine 150 is not operating (No in operation S720), the VCU 210 may continue monitoring the voltage in operation S710.

In an example embodiment, the VCU 210 may determine whether the voltage of the battery 110 is below a predetermined charging reference voltage, and may control the power generation engine 150 to operate.

When it is determined that the power generation engine 150 is operating (Yes in operation S720), the VCU 210 may determine in operation S730 whether the voltage of the battery 110 is below the predetermined charging reference voltage.

The charging reference voltage may be based on the voltage corresponding to a specific state of charge (SOC) value (e.g., required) for charging the battery 110. Additionally, instead of comparing the voltage of the battery 110 with the charging reference voltage, the VCU 210 may determine whether the SOC of the battery 110 is below a predetermined charging reference SOC.

When the voltage of the battery 110 is greater than the predetermined charging reference voltage (No in operation S730), the VCU 210 may continue to monitor the voltage in operation S710.

When the voltage of the battery 110 is less than the predetermined charging reference voltage (Yes in operation S730), the VCU 210 may determine the charging voltage V2 in operation S740.

More specifically, the VCU 210 may determine the voltage of the battery 110 and determine a charging voltage V2 that is greater than the determined voltage of the battery 110.

Sequentially, the VCU 210 may determine the voltage conversion duty ratio of the control signal output from the power converter 170 in operation S750 and control the output of the control signal corresponding to the determined voltage conversion duty ratio to the power converter 170 in operation S760.

In an example embodiment, the VCU 210 determines the voltage conversion duty ratio based on the rectified voltage V1 and the determined charging voltage V2, and may control the power generation motor controller 260 to output the control signal corresponding to the determined voltage conversion duty ratio to the switch S of the buck-boost converter 172.

Next, the VCU 210 may determine in operation S770 whether the charging voltage V2 is greater than the voltage of the battery 110.

When the charging voltage V2 is less than the voltage of the battery 110 (No in operation S770), the VCU 210 may re-determine in operation S720 whether the power generation engine 150 is operating and whether the power generation engine 150 is performing its power generation operation.

Subsequently, the VCU 210 may determine in operation S780 whether to maintain control of the charging voltage V2 for the battery 110.

Specifically, the VCU 210 may perform control of the charging voltage V2 by outputting the control signal corresponding to the determined voltage conversion duty ratio to the buck-boost converter 171 of the power converter 170. In an example embodiment, even when the power generation of the power generation motor 160 and the voltage of the battery 110 change, the VCU 210 may adjust the magnitude of the charging voltage V2 being supplied to stably charge the battery 110.

Meanwhile, the disclosure may be provided (e.g., implemented) as code recorded on a computer-readable medium containing a program. Computer-readable media include (e.g., all) types of recording devices in which data readable by a computer system are stored. Examples of the computer-readable media include Hard Disk Drive (HDD), Solid State Disk (SSD), Silicon Disk Drive (SDD), ROM, RAM, CD-ROM, magnetic tape, floppy disk, optical data storage device, and the like. Accordingly, the above detailed description should not be construed as restrictive in (e.g., all) respects but as exemplary. The scope of the disclosure should be determined by a reasonable interpretation of the claims herein and includes (e.g., all) modifications within the scope of the disclosure.

What is claimed is:

1. An electrified vehicle comprising:
a battery;
an engine;
a motor configured to generate power by receiving mechanical energy from the engine;
a power converter configured to rectify alternating current (AC) power generated by the motor into direct current (DC) power, convert voltage of the rectified power into a charging voltage, and output the converted voltage to the battery; and
a controller configured to determine a voltage conversion duty ratio based on the voltage of the rectified power and the voltage of the battery,
wherein the power converter converts the voltage of the rectified power into the charging voltage based on a control signal corresponding to the voltage conversion duty ratio.

2. The electrified vehicle of claim 1, wherein the power converter comprises a buck-boost converter configured to step up or step down the charging voltage based on the voltage conversion duty ratio.

3. The electrified vehicle of claim 2, wherein the buck-boost converter comprises a switch disposed at an input terminal configured to receive the rectified power, the switch being controlled to turn on and off based on the control signal.

4. The electrified vehicle of claim 3, wherein the switch disposed at the input terminal comprises a plurality of switching elements connected in series.

5. The electrified vehicle of claim 1, wherein the motor comprises a three-phase motor, and the power converter comprises a three-phase rectifier configured to convert three-phase AC power generated from the power generation motor into DC power.

6. The electrified vehicle of claim 1, wherein the controller determines the charging voltage based on the voltage of the battery and determines the voltage conversion duty ratio based on the charging voltage and the voltage of the rectified power.

7. The electrified vehicle of claim 1, wherein the controller further determines whether the voltage of the battery is below a preset reference voltage and controls the engine to operate based on the voltage of the battery being below the preset reference voltage.

8. The electrified vehicle of claim 1, wherein the engine is operated in a preset driving mode based on an energy efficiency of the engine.

9. A method for controlling an electrified vehicle, the method comprising:
operating an engine by a controller;
generating power via a motor by receiving mechanical energy from the engine;
rectifying alternating current (AC) power generated by the motor into direct current (DC) power via a power converter; and
determining, by the controller, a voltage conversion duty ratio based on the voltage of the rectified power and the voltage of a battery,
wherein the power converter converts the voltage of the rectified power into a charging voltage based on a control signal corresponding to the voltage conversion duty ratio.

10. The method of claim 9, wherein the power converter comprises a buck-boost converter configured to step up or step down the charging voltage based on the voltage conversion duty ratio.

11. The method of claim 10, wherein the buck-boost converter comprises a switch disposed at an input terminal configured to receive the rectified power, the switch being controlled to turn on and turn off based on the control signal.

12. The method of claim 11, wherein the switch disposed at the input terminal comprises a plurality of switching elements connected in series.

13. The method of claim 9, wherein the motor comprises a three-phase motor, and the power converter comprises a three-phase rectifier configured to convert three-phase AC power generated from the power generation motor into DC power.

14. The method of claim 9, wherein the determining of the duty ratio comprises determining, by the controller, the charging voltage based on the voltage of the battery and determining the voltage conversion duty ratio based on the charging voltage and the voltage of the rectified power.

15. The method of claim 9, further comprising:
determining whether the voltage of the battery is below a preset reference voltage; and
operating the engine based on the voltage of the battery being below the preset reference voltage.

16. The method of claim 9, wherein the engine is operated in a preset operating mode based on an energy efficiency of the engine.
